(19) United States
(12) Patent Application Publication
(10) Pub. No.: US 2024/0380800 A1
(43) Pub. Date: Nov. 14, 2024

(54) VIRTUAL WHITEBOARD FOR REAL-TIME COLLABORATION IN A USER INTERFACE OF A VIDEO CONFERENCE SYSTEM

(71) Applicant: Google LLC, Mountain View, CA (US)

(72) Inventors: Kathleen Alexandra Bryan, Mountain View, CA (US); Shiblee Imtiaz Hasan, Santa Clara, CA (US)

(21) Appl. No.: 18/196,595

(22) Filed: May 12, 2023

(51) Int. Cl. H04L 65/403; G06F 3/01; G06F 3/0484; G06F 40/103; G06V 20/40; G06V 40/20

(52) U.S. Cl. CPC H04L 65/403; G06F 3/017; G06F 3/0484; G06F 40/103; G06V 20/41; G06V 40/20

(57) ABSTRACT

A first event associated with a first client device of multiple client devices of participants of a video conference is identified. The first event indicates a request to activate a virtual whiteboard for presentation in a user interface (UI) including regions that display visual items that each correspond to one of multiple video streams from the client devices. Responsive to identifying the first event, a virtual whiteboard UI element for real-time display of content among the participants of the video conference is provided for presentation within instances of the UI at the client devices. A second event associated with the first client device indicating first content for presentation within the virtual whiteboard UI element is identified. The first content is provided for presentation at the client devices within respective instances of the virtual whiteboard UI element.

### FIELD OF THE INVENTION

Aspects and embodiments of the disclosure relate to a user interface of a video conference, and in more specifically, a virtual whiteboard for real-time content collaboration.

### BACKGROUND

Video conferences can take place between multiple participants via a video conference platform. A video conference platform includes tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the video conference platform can provide a user interface that includes multiple regions to display the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including identifying a first event associated with a first client device of a plurality of client devices of a plurality of participants of a video conference, the first event indicating a request to activate a virtual whiteboard for presentation in a user interface (UI) comprising a plurality of regions that display a plurality of visual items each corresponding to one of a plurality of video streams from the plurality of client devices; responsive to identifying the first event, providing, for presentation within instances of the UI at the plurality of client devices, a virtual whiteboard UI element for real-time display of content among the plurality of participants of the video conference; identifying a second event associated with the first client device indicating first content for presentation within the virtual whiteboard UI element; and providing, for presentation at the plurality of client devices, the first content within respective instances of the virtual whiteboard UI element.

In some embodiments, identifying the first event associated with the first client device of the plurality of client devices of the plurality of participants of the video conference, comprises: receiving, from the first client device, a first video segment of a first video stream of the plurality of video streams; and performing a first computer vision operation on the first video segment to detect a video gesture that qualifies as a predetermined video gesture indicative of the request to activate the virtual whiteboard for presentation in the UI.

In some embodiments, identifying the second event associated with the first client device indicating the first content for presentation within the virtual whiteboard UI element, comprises: receiving, from the first client device, a second video segment of a second video stream of the plurality of video streams; performing, on the second video segment, a second computer vision operation that detects one or more video gestures associated with a first user of the first client device; and determining the first content based on the one or more video gestures associated with the first user.

In some embodiments, performing the first computer vision operation on the first video segment to detect the video gesture that qualifies as the predetermined video gesture indicative of the request to activate the virtual whiteboard for presentation in the UI, comprises: sampling a subset of frames of the first video segment; performing the first computer vision operation on the subset of frames of the first video segment; and wherein performing, on the second video segment, the second computer vision operation that detects one or more video gestures associated with the first user of the first client device, comprises: performing the second computer vision operation on a plurality of frames of the second video segment.

In some embodiments, performing, on the second video segment, the second computer vision operation that detects one or more video gestures associated with the first user of the first client device, comprises: performing a ray casting operation that projects a line from an object associated with the first user to a location on a virtual plane and detects changes in the location on the virtual plane based on movement of the object.

In some embodiments, the virtual whiteboard UI element is presented as a background layer of a first visual item of the plurality of visual items, the first visual item representing a first video stream from the first client device.

In some embodiments, identifying the first event associated with the first client device of the plurality of client devices of the plurality of participants of the video conference, comprises: receiving an indication of a user selection of a UI element of the UI that indicates the request to activate the virtual whiteboard for presentation in the UI.

In some embodiments, the method includes identifying a third event associated with a second client device of the plurality of client devices, the third event indicating second content for presentation within the virtual whiteboard UI element; and providing, for presentation at the plurality of client devices, the second content within respective instances of the virtual whiteboard UI element.

In some embodiments, the method includes filtering the first content and the second content to identify third content based on a criterion; and providing, for presentation at the plurality of client devices, the third content within respective instances of a new virtual whiteboard UI element.

In some embodiments, the method includes converting the first content of the virtual whiteboard UI element into content for a document application; and providing access to a file of the document application, the file comprising the content converted from a first format of the first content of the virtual whiteboard UI element to a second format of the file.

A further aspect of the disclosure provides a system comprising: a memory; and a processing device, coupled to the memory, the processing device to perform a method according to any aspect or embodiment described herein. A further aspect of the disclosure provides a computer-readable medium comprising instructions that, responsive to execution by a processing device, cause the processing device to perform operations comprising a method according to any aspect or embodiment described herein.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding only.

FIG. 1 illustrates an example system architecture, in accordance with embodiments of the disclosure.

FIG. 2 is a block diagram illustrating an example virtual whiteboard manager, in accordance with embodiments of the disclosure.

FIG. 3A-3F illustrate examples of user interfaces for a video conference and that enable a virtual whiteboard UI element, in accordance with some embodiments of the disclosure.

FIG. 4 depicts a flow diagram of a method for implementing a virtual whiteboard for presentation in a user interface (UI) of a video conference, in accordance with embodiments of the disclosure.

FIG. 5 illustrates a high-level component diagram of an example system architecture for a generative machine learning model, in accordance with one or more aspects of the disclosure.

FIG. 6 depicts an example computer system that can perform any one or more of the methods described herein, in accordance with some embodiments of the disclosure.

### DETAILED DESCRIPTION

Aspects of the disclosure relate to providing a virtual whiteboard UI element in a user interface (UI) of a video conference platform for real-time content collaboration (e.g., the creation, sharing, and modification of content with participants of a video conference). A video conference platform can enable video-based conferences between multiple participants via respective client devices that are connected over a network and share each other's audio data (e.g., voice of a user recorded via a microphone of a client device) and/or video data (e.g., a video captured by a camera of a client device) during a video conference. In some instances, a video conference platform can enable a significant number of client devices (e.g., up to one hundred or more client devices) to be connected via the video conference.

A participant of a video conference can speak (e.g., present on a topic) to the other participants of the video conference. Some existing video conference platforms can provide a user interface (UI) (e.g., video conference UI) to each client device connected to the video conference. The UI displays the video streams from the client devices over the network in a set of regions in the UI. For example, the video stream of a participant who is speaking to the other participants in the video conference can be displayed in a designated, often larger, region of the UI of the video conference platform, and other participants who are not speaking can be displayed in other, often smaller, regions.

Some video conference systems allow a participant to share a screen of a local display with the other participants of the video conference. However, many video conference systems do not provide robust features that allow participants to create, share, or modify content in collaboration with other participants in real-time.

Aspects of the disclosure address the above and other deficiencies by providing a virtual whiteboard (e.g., virtual whiteboard UI element) within the UI of the video conference. A virtual whiteboard can refer to a software application or software element (e.g., virtual whiteboard UI element) that emulates a traditional whiteboard and supports real-time content collaboration with participants of a video conference. Content from one or more participants of a video conference can be created, displayed and modified within the virtual whiteboard UI element.

In some embodiments, a participant can request activation of a virtual whiteboard for presentation in a video conference UI that includes multiple regions. Each region can include a visual item, such as a video stream from a client device of a respective participant of the video conference. Multiple modalities can be used to request activation of the virtual whiteboard, including but not limited to, keyboard input, mouse input, voice commands, a UI element of the video conference UI, or video gestures. A video gesture can refer to a physical movement, action, or physical orientation made by a person or character that is captured on video. For example, a participant may make a video gesture such as pointing an index finger and/or making a drawing motion with the index finger. A computer vision operation can be performed on video frames of the participant's video stream (e.g., a video stream from the participant's client device). A computer vision operation can include one or more operations that interpret visual data (e.g., video data such as a video segment including multiple frames). In some embodiments, a computer vision operation can include using the visual data, such a video segment of a video stream, to identify and/or classify objects in the video (e.g., frames of a video). The computer vision operation can interpret the video gesture from the video frames as a request to activate a virtual whiteboard. Responsive to the request to activate a virtual whiteboard, the video conference system can provide for presentation a virtual whiteboard UI element in the instances of the video conference UI. In some embodiments, the virtual whiteboard UI element can be composited as a background layer of the requesting participant's video stream.

In some embodiments, the requesting participant can grant permission to one or more of the other participants to create or modify content within the virtual whiteboard UI element for real-time content collaboration. In some embodiments, multiple modalities (as described above) can be used to create and modify content that is presented in the virtual whiteboard UI element. For instance, a participant can use a mouse to locate a cursor on the virtual whiteboard UI element and subsequently use one or more video gestures to draw items on the virtual whiteboard UI element.

In some embodiments, the content of one or more virtual whiteboard UI elements can be copied to another virtual whiteboard UI element, such a new virtual whiteboard requested by another participant of the video conference. In some embodiments, the content of one or more virtual whiteboard UI elements can be filtered based on one or more criteria, such as by participant contribution, a location in the virtual whiteboard UI element, time range, or specified virtual whiteboard UI element. The filtered content can be displayed on a new virtual whiteboard UI element.

In some embodiments, the content of one or more virtual whiteboard UI elements can be provided to a participant as “notes” or a “summary.” For example, the content (filtered or unfiltered) can be provided in a data file that is compatible with a document application, such as a text editing application. In some embodiments, the content of one or more virtual whiteboard UI elements can be used as input (e.g., query) to a trained generative machine learning model, and the trained generative machine learning model can generate new content (e.g., summary) of the original content from the one or more virtual whiteboard UI elements.

Aspects of the disclosure provide technical advantages over previous solutions. Aspects of the disclosure can provide additional functionality to the video conference tool of the video conference platform that intelligently brings a virtual whiteboard UI element for real-time content collaboration in a video conference. Such additional functionality can also result in more efficient use of processing resources utilized to facilitate the creation, sharing, modification of content between client devices by avoiding consumption of computing resources needed to support participants and/or hosts using collaboration applications outside of the video conference environment or manually managing content sharing, thereby resulting in an increase of overall efficiency and functionality of the video conference platform.

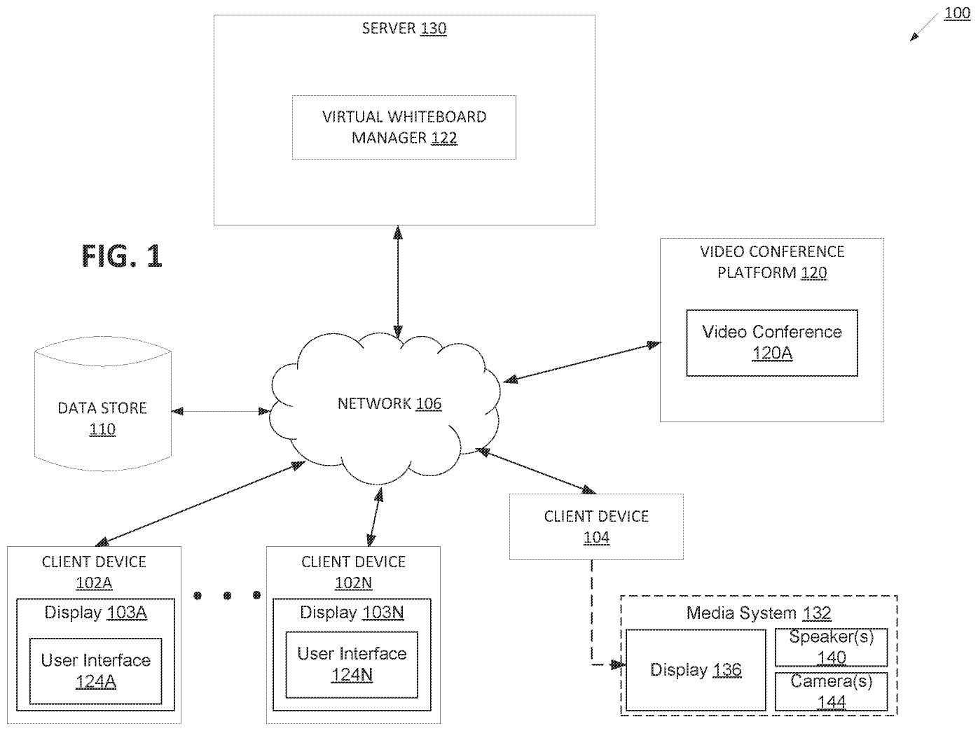

FIG. 1 illustrates an example system architecture 100, in accordance with embodiments of the disclosure. The system architecture 100 (also referred to as “system” herein) includes client devices 102A-N, one or more client devices 104, a data store 110, a video conference platform 120, and a server 130, each connected to a network 106.

In embodiments, network 106 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 110 is a persistent storage that is capable of storing data as well as data structures to tag, organize, and index the data. A data item can include audio data and/or video stream data, in accordance with embodiments described herein. Data store 110 can be hosted by one or more storage devices, such as main memory, magnetic or optical storage-based disks, tapes or hard drives, NAS, SAN, and so forth. In some embodiments, data store 110 can be a network-attached file server, while in other embodiments data store 110 can be some other type of persistent storage such as an object-oriented database, a relational database, and so forth, that may be hosted by video conference platform 120 or one or more different machines (e.g., the server 130) coupled to the video conference platform 120 via network 106. In some embodiments, the data store 110 can store portions of audio and video streams received from the client devices 102A-102N for the video conference platform 120. Moreover, the data store 110 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents may be shared with users of the client devices 102A-102N and/or concurrently editable by the users.

Video conference platform 120 can enable users of client devices 102A-102N and/or client device(s) 104 to connect with each other via a video conference (e.g., a video conference 120A). A video conference refers to a real-time communication session such as a video conference call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. For example, in a real-time communication of an event, such as a video conference, segments of the video streams of the video conference are sent to participating client devices before the event has concluded (e.g., while the event is ongoing). Video conference platform 120 can allow a user to join and participate in a video conference call with other users of the platform. Embodiments of the disclosure can be implemented with any number of participants connecting via the video conference (e.g., up to one hundred or more).

The client devices 102A-102N may each include computing devices such as personal computers (PCs), laptops, mobile phones, smart phones, tablet computers, netbook computers, network-connected televisions, etc. In some embodiments, client devices 102A-102N may also be referred to as “user devices.” Each client device 102A-102N can include an audiovisual component that can generate audio and video data to be streamed to video conference platform 120. In some embodiments, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some embodiments, the audiovisual component can also include an image capture device (e.g., a camera) to capture images and generate video data (e.g., a video stream) of the captured data of the captured images.

In some embodiments, video conference platform 120 is coupled, via network 106, with one or more client devices 104 that are each associated with a physical conference or meeting room. Client device(s) 104 may include or be coupled to a media system 132 that may comprise one or more display devices 136, one or more speakers 140 and one or more cameras 144. Display device 136 can be, for example, a smart display or a non-smart display (e.g., a display that is not itself configured to connect to network 106). Users that are physically present in the room can use media system 132 rather than their own devices (e.g., client devices 102A-102N) to participate in a video conference, which may include other remote users. For example, the users in the room that participate in the video conference may control the display devices 136 to show a slide presentation or watch slide presentations of other participants. Sound and/or camera control can similarly be performed. Similar to client devices 102A-102N, client device(s) 104 can generate audio and video data to be streamed to video conference platform 120 (e.g., using one or more microphones, speakers 140 and cameras 144).

Each client device 102A-102N or 104 can include a web browser and/or a client application (e.g., a mobile application, a desktop application, etc.). In some embodiments, the web browser and/or the client application can present, on a display device 103A-103N of client device 102A-102N, a user interface (UI) (e.g., a UI of the UIs 124A-124N) for users to access video conference platform 120. For example, a user of client device 102A can join and participate in a video conference via a UI 124A presented on the display device 103A by the web browser or client application. A user can also present a document to participants of the video conference via each of the UIs 124A-124N. Each of the UIs 124A-124N can include multiple regions to present visual items corresponding to video streams of the client devices 102A-102N provided to the server 130 for the video conference.

In some embodiments, server 130 can include a virtual whiteboard manager 122. Virtual whiteboard manager 122 is configured to manage a video conference between multiple users of video conference platform 120. In some embodiments, virtual whiteboard manager 122 can provide the UIs 124A-124N to each client device to enable users to watch and listen to each other during a video conference. Virtual whiteboard manager 122 can also collect and provide data associated with the video conference to each participant of the video conference. In some embodiments, virtual whiteboard manager 122 can provide the UIs 124A-124N for presentation by a client application (e.g., a mobile application, a desktop application, etc.). For example, the UIs 124A-124N can be displayed on a display device 103A-103N by a native application executing on the operating system of the client device 120A-120N or the client device 104. The native application may be separate from a web browser. In some embodiments, the virtual whiteboard manager 122 can determine visual items for presentation in the UI 124A-124N during a video conference. A visual item can refer to a UI element that occupies a particular region in the UI and is dedicated to presenting a video stream from a respective client device. Such a video stream can depict, for example, a user of the respective client device while the user is participating in the video conference (e.g., speaking, presenting, listening to other participants, watching other participants, etc., at particular moments during the video conference), a physical conference or meeting room (e.g., with one or more participants present), a document or media content (e.g., video content, one or more images, etc.) being presented during the video conference, a virtual whiteboard, a combination thereof, etc. For example, virtual whiteboard manager 122 can identify an event associated with a first client device of multiple client devices of participants of a video conference. The first event can indicate a request for a virtual whiteboard for presentation within the UI of the video conference. Virtual whiteboard manager 122 can provide a virtual whiteboard UI element for presentation within an instance of the UI at each of the multiple client devices. For instance, the virtual whiteboard UI element can be presented as a background layer of the video stream of the first user associated with the first client device. Virtual whiteboard manager 122 can identify a second event associated with the first client device identifying first content for presentation within the virtual whiteboard UI element. Virtual whiteboard manager 122 can provide for presentation at the multiple client devices, the first content in respective instances of the virtual whiteboard UI element.

As described previously, an audiovisual component of each client device can capture images and generate video data (e.g., a video stream) of the captured data of the captured images. In some embodiments, the client devices 102A-102N and/or client device(s) 104 can transmit the generated video stream to virtual whiteboard manager 122. The audiovisual component of each client device can also capture an audio signal representing speech of a user and generate audio data (e.g., an audio file or audio stream) based on the captured audio signal. In some embodiments, the client devices 102A-102N and/or client device(s) 104 can transmit the generated audio data to virtual whiteboard manager 122.

In some embodiments, video conference platform 120 and/or server 130 can be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a video conference. Video conference platform 120 may also include a website (e.g., a webpage) or application back-end software that may be used to enable a user to connect with other users via the video conference.

It should be noted that in some other embodiments, the functions of server 130 or video conference platform 120 may be provided by a fewer number of machines. For example, in some embodiments, server 130 may be integrated into a single machine, while in other embodiments, server 130 may be integrated into multiple machines. In addition, in some embodiments, server 130 may be integrated into video conference platform 120.

In general, functions described in embodiments as being performed by video conference platform 120 or server 130 can also be performed by the client devices 102A-N and/or client device(s) 104 in other embodiments, if appropriate. In addition, the functionality attributed to a particular component can be performed by different or multiple components operating together. Video conference platform 120 and/or server 130 can also be accessed as a service provided to other systems or devices through appropriate application programming interfaces, and thus is not limited to use in websites.

Although embodiments of the disclosure are discussed in terms of video conference platform 120 and users of video conference platform 120 participating in a video conference, embodiments may also be generally applied to any type of telephone call or conference call between users. Embodiments of the disclosure are not limited to video conference platforms that provide video conference tools to users.

In embodiments of the disclosure, a “user” may be represented as a single individual. However, other embodiments of the disclosure encompass a “user” being an entity controlled by a set of users and/or an automated source. For example, a set of individual users federated as a community in a social network may be considered a “user.” In another example, an automated consumer may be an automated ingestion pipeline, such as a topic channel, of the video conference platform 120.

In situations in which the systems discussed here collect personal information about users, or may make use of personal information, the users may be provided with an opportunity to control whether video conference platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the video conference platform 120 and/or server 130.

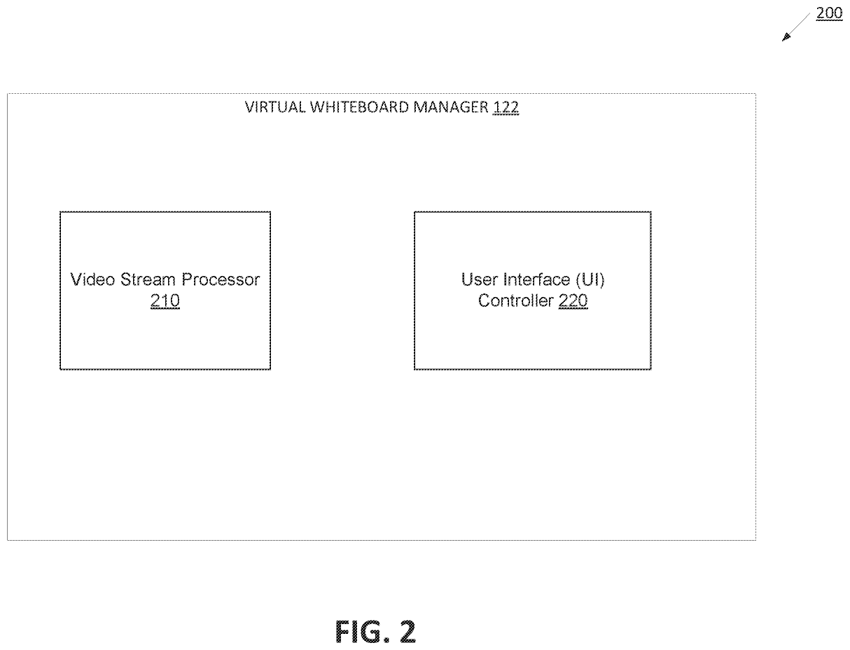

FIG. 2 is a block diagram illustrating an example virtual whiteboard manager 122, in accordance with embodiments of the disclosure. The virtual whiteboard manager 122 includes a video stream processor 210 and a user interface (UI) controller 220. The components can be combined together or separated into further components, according to a particular embodiment. It should be noted that in some embodiments, various components of the virtual whiteboard manager 122 may run on separate machines.

The video stream processor 210 can receive video streams from the client devices (e.g., from client devices 102A-102N and/or 104). The video stream processor 210 can determine visual items for presentation in the UI (e.g., the UIs 124A-124N) during a video conference. Each visual item can at least correspond to a video stream from a client device (e.g., the video stream pertaining to one or more participants of the video conference). In some embodiments, a visual item can correspond to a virtual whiteboard UI element. In some embodiments, the video stream processor 210 can receive audio streams associated with the video streams from the client devices (e.g., from an audiovisual component of the client devices 102A-102N). Once the video stream processor has determined visual items for presentation in the UI, the video stream processor 210 can notify the UI controller 220 of the determined visual items.

The UI controller 220 can provide the UI for a video conference. The UI can include multiple regions. In some embodiments, each region can display a video stream pertaining to one or more participants (e.g., users) of the video conference. In some embodiments, a region can display a virtual whiteboard UI element. In some embodiments, the virtual whiteboard UI element can be implemented within a video stream pertaining to one or more participants of the video conference (e.g., as a background layer of the video stream). The UI controller 220 can control which video stream and/or virtual whiteboard UI element is to be displayed by providing a command to the client devices that indicates which video stream and/or virtual whiteboard UI element is to be displayed in which region of the UI (along with the received video and audio streams being provided to the client devices). For example, in response to being notified of the determined visual items for presentation in the UI 124A-124N, the UI controller 220 can transmit a command causing each determined visual item to be displayed in a region of the UI and/or rearranged in the UI.

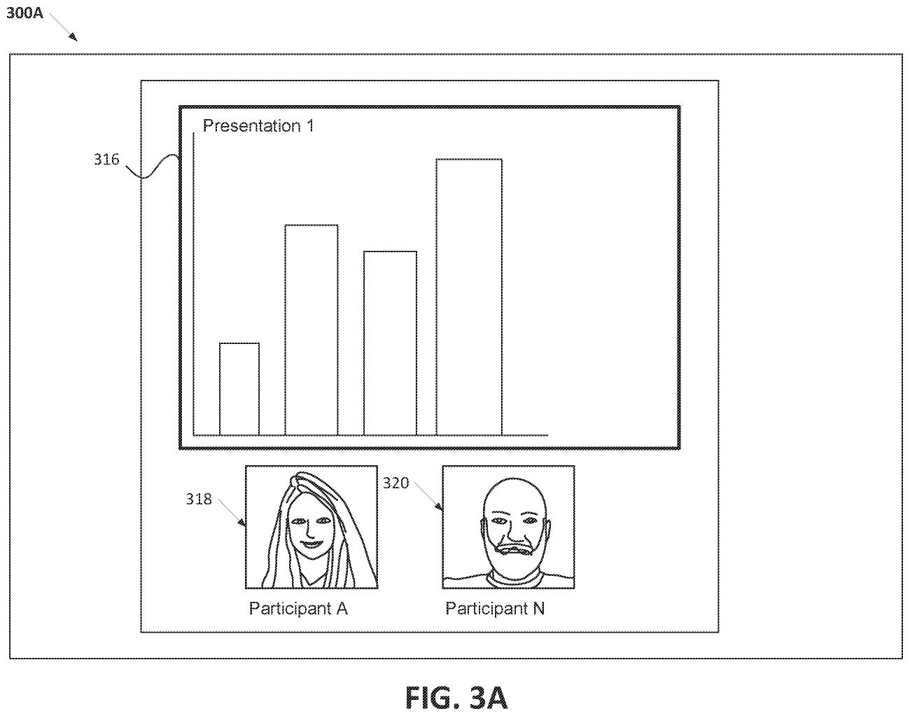

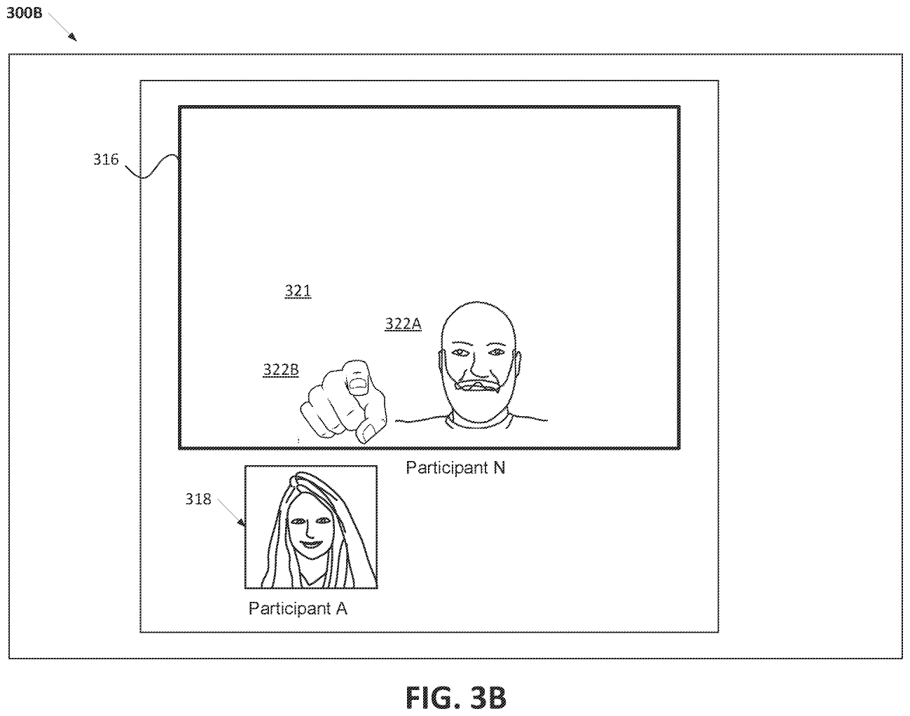

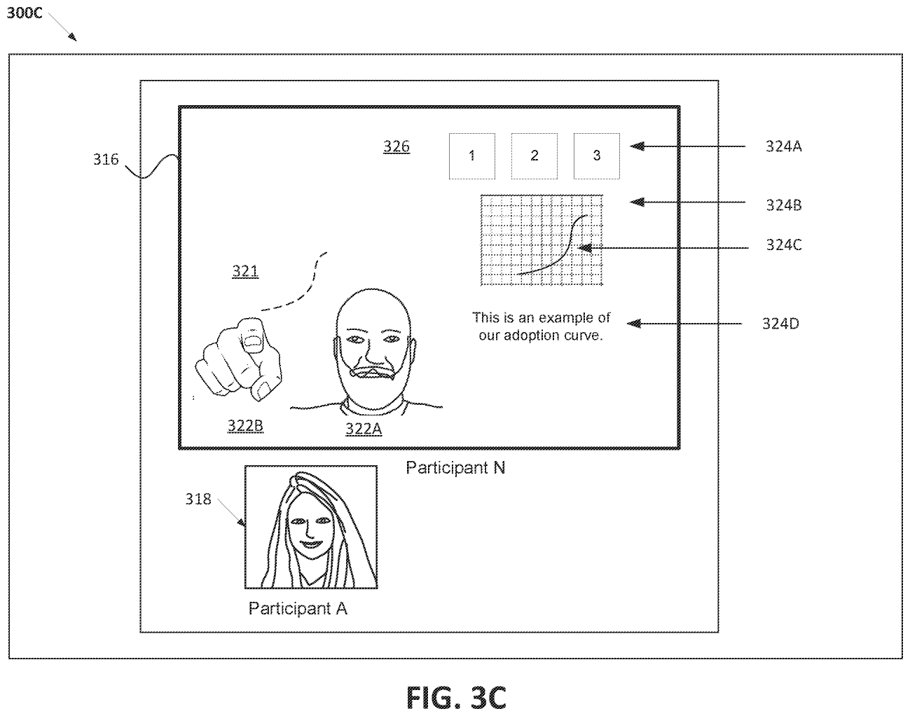

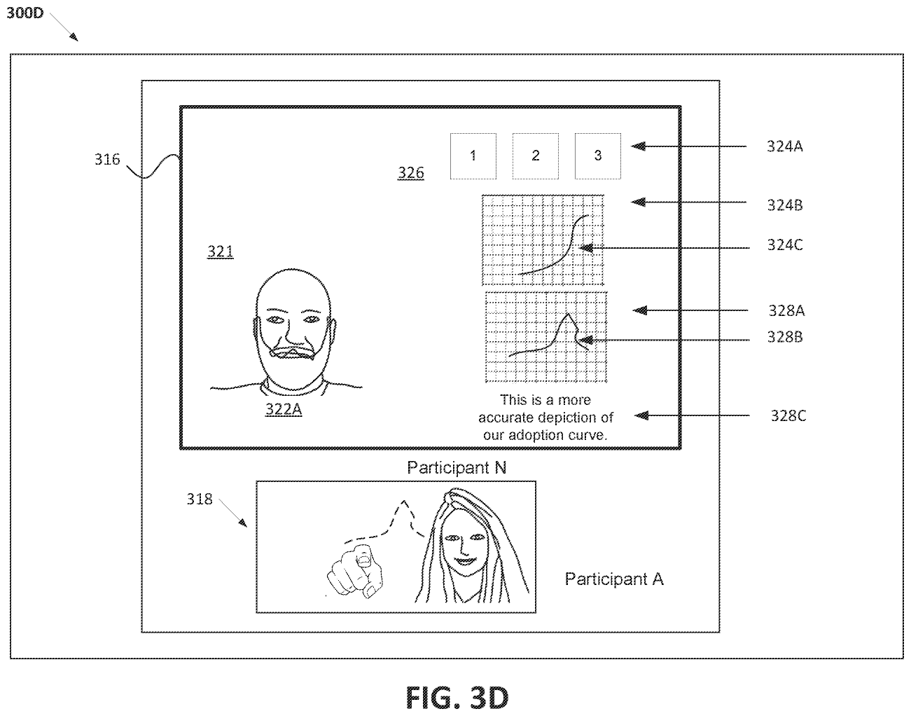

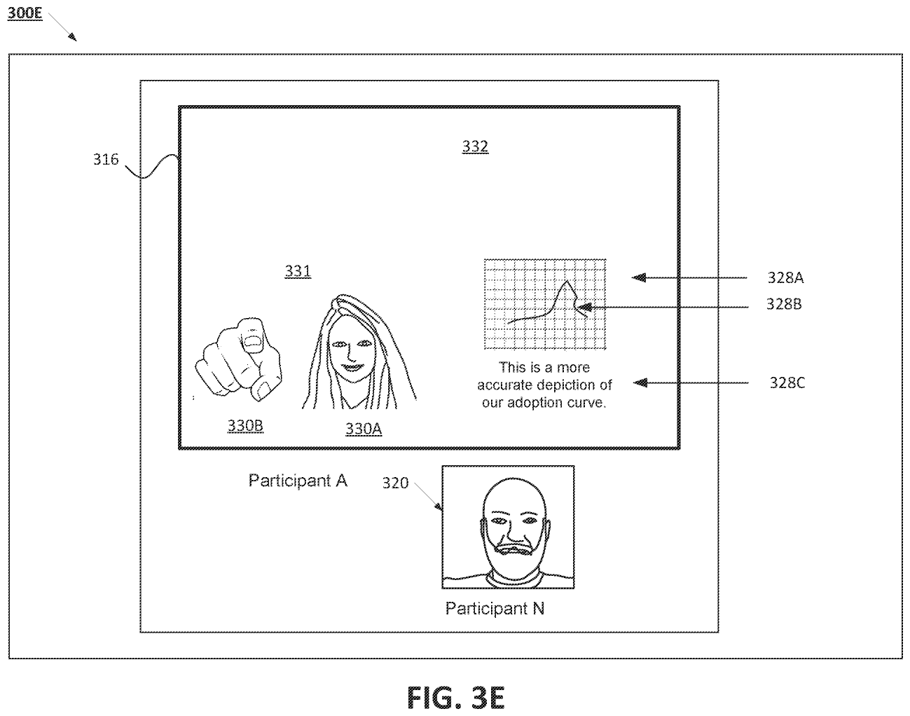

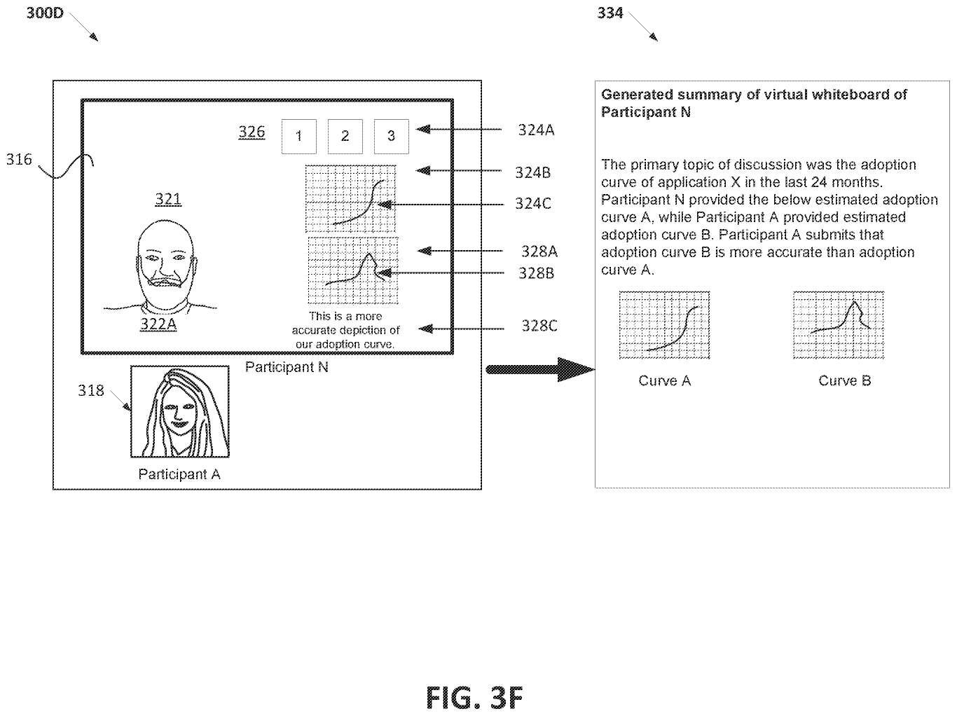

FIG. 3A-3F illustrate examples of user interfaces for a video conference and that enable a virtual whiteboard UI element, in accordance with some embodiments of the disclosure.

FIG. 3A illustrates an example user interface 300A for a video conference, in accordance with some embodiments of the disclosure. UI 300A through UI 300E are generally referred to as UI 300. The UI 300 can be generated by the virtual whiteboard manager 122 of FIG. 1 for presentation at one or more client devices (e.g., client devices 102A-102N and/or 104). Accordingly, the UI 300 can be generated by one or more processing devices of the server 130 of FIG. 1. In some embodiments, the video conference between multiple participants can be managed by the video conference platform 120. As illustrated, the virtual whiteboard manager 122 can provide the UI 300A to enable participants (e.g., participants A-N) to join and participate in the video conference.

UI 300A can include multiple regions, such as a first region 316, a second region 318, and a third region 320. The first region 316 displays a visual item corresponding to video data (e.g., a video stream) of a document being presented. A document can be a slide presentation, a word processing document, a spreadsheet document, a web page, or any other document that can be presented. In one embodiment, a client device can open (e.g., in response to a user operation) a document on the screen using an appropriate document application and share (e.g., in response to a user operation) the screen presenting the document with client devices of the other participants by providing a video stream of the document. In the present example, the document is being shared by participant N.

Second region 318 can display a visual item corresponding to video data captured and/or streamed by a client device associated with Participant A. Third region 320 can display a visual item corresponding to video data captured and/or streamed by a client device associated with Participant N. As illustrated, the first region 316 can correspond to a “main region,” e.g., an area in the UI 300A that is placed at or near the center or a focus area of the UI 300A. In some embodiments, the second region 318 and the third region 320 can correspond to “thumbnail regions.” A thumbnail region can refer to an area of the UI 300A that can be located along a side (e.g., a bottom side) of the UI 300A. Similar to the main region, the thumbnail region is also associated with a video stream received from the client device and displays the video stream. However, the thumbnail region spans a smaller area than the main region, thereby presenting images of the associated video stream in a relatively smaller scale than the main region.

In some embodiments, the first region 316 is relatively bigger than the second region 318 and the third region 320 to catch the attention of participants in the video conference (e.g., users of the client devices).

In some embodiments, there can be more than one main region. In some embodiments, each region is of the same or similar size as the size of each other region. In some embodiments, the first region 316 can be used to display a video stream from a client device associated with an active and/or current speaker and/or presenter of the video conference.

In some embodiments, the virtual whiteboard manager 122 can associate each region with a visual item corresponding to a video stream received from a client device. For example, the processing device can determine that the second region 318 is to display a visual item corresponding to a video stream from the client device of Participant A (e.g., based on an identifier associated with each client device and/or each participant). In some embodiments, this can be done automatically without any user input specifying which visual item is to be displayed in the second region 318 in the UI 300A.

In some embodiments, the UI 300 can also include an options region (not illustrated) for providing selectable options (e.g., UI elements) to adjust display settings (e.g., a size of each region, a number of regions, a selection of a video stream, etc.), invite additional users to participate, active a virtual whiteboard UI element, etc. In some embodiments, the UI 300 can also include an options region (not illustrated) for providing selectable options to adjust display settings (e.g., a size of each region, a number of regions, a selection of a video stream, etc.), invite additional users to participate, etc.

FIG. 3B illustrates an example user interface 300B for a video conference where a user is requesting an activation of a virtual whiteboard, in accordance with some embodiments of the disclosure. UI 300B illustrates the first region 316 that displays a visual item 321 corresponding to a video stream from the client device of Participant N. visual item 321 can include visual object 322B showing Participant N's pointed finger and closed first and visual object 322A showing the Participant N's face. The second region 318 displays a visual item corresponding to a video stream from the client device of participant A. The third region 320 has been removed from UI 300B.

In some embodiments, virtual whiteboard manager 122 can identify an event associated with a client device (e.g., client device N associated with participant N). The event (e.g., activation event) can indicate a request to activate a virtual whiteboard for presentation in the UI 300.

In some embodiments, the activation request can be for a virtual whiteboard for a single user, such as participant N of client device N. In some embodiments, the activation request can be for a virtual whiteboard for multiple users for real-time content collaboration.

In some embodiments, the event can include a selection of a UI element (not shown) of UI 300B that requests activation of a virtual whiteboard. In some embodiments, the event can include a user input, such as a keyboard input, touch pad input, or mouse input that requests the activation of the virtual whiteboard. In some embodiments, the event can include a voice command requesting activation of a virtual whiteboard.

In some embodiments, the event can include a video gesture that is detected by virtual whiteboard manager 122. A video gesture can refer to a physical movement, action, or physical orientation made by a person or character that is captured on video. For example, virtual whiteboard manager 122 can perform a computer vision operation on a video segment on the video stream of participant N to detect a video gesture that qualifies as a predetermined video gesture indicative of a request to activate the virtual whiteboard for presentation in UI 300. A video segment can be part of a video stream and include multiple video frames (also referred to as “frames” herein). In some embodiments, video gesture detection can include detecting the movement of an object (e.g., predetermined object), such as the user's finger, stylus, or pen.

As illustrated in FIG. 3B, participant N uses an object, such as the user's finger to indicate that participant N is requesting activation of the virtual whiteboard. For example, participant N points an index finger (or starts drawing with an index finger) to request activation of the virtual whiteboard. Virtual whiteboard manager 122 can receive a video segment of the video stream of participant N that includes the pointing of the index finger. Virtual whiteboard manager 122 can perform a computer vision operation on the video gesture to determine whether the video gesture qualifies as a predetermined video gesture that corresponds with a request to activate a virtual whiteboard. If the virtual whiteboard manager 122 determines that the video gesture qualifies as the predetermined video gesture, virtual whiteboard manager 122 can activate the virtual whiteboard UI element for display in the UI 300, as illustrated in FIG. 3C. If virtual whiteboard manager 122 determines that the video gesture does not qualify as the predetermined video gesture, virtual whiteboard manager 122 does not activate the virtual whiteboard UI element and continues to present the visual item corresponding to a video stream from the client device of Participant N.

A computer vision operation can include one or more operations that interpret visual data (e.g., video data such as a video segment including multiple frames). In some embodiments, a computer vision operation can include using the visual data, such a video segment of a video stream, to identify and classify objects in the image or video. In some embodiments, a computer vision operation can identify and interpret human gestures using the visual data. The gestures can include hand gestures, body movement, facial expression or other physical actions made by humans. In some embodiments, the computer vision operation can detect changes between frames of a video segment. In some embodiments, machine learning techniques such as machine learning models trained on training data that pairs inputs within known outputs is implemented to perform a computer vision operation for gesture recognition.

In some embodiments, the computer vision operation to detect an activation event can include an optimization operation. In some embodiments, performing a computer vision operation on all the frames of a video segment to detect an activation event can use a large amount of computer resources (e.g., memory resources or computational resources). In some embodiments, the computer vision operation to detect an activation event can include sampling a subset of frames of the video segment (e.g., sampling the frames below the frame rate, such as 1 out of 3 frames or 1 out of 10 frames) and performing the computer vision operation on the subset of frames to reduce the computer resources used to identify an activation event.

In some embodiments, the optimization operation of the computer vision operation can use lower resolution frames (e.g., lower than received from the client device) in detecting the activation event. In some embodiments, the optimization operation of the computer vision operation also includes performing the computer vision operation only on a predetermined object (e.g., the user's hands) and excluding the remaining content of the video frames from analysis. In some embodiments, one or more the optimization operations, as described herein, can be combined.

In some embodiments, subsequent to identifying the activation event using an optimization operation (e.g., optimization technique), virtual whiteboard manager 122 can return to full-frame rate video gesture detection, as illustrated in FIG. 3C.

In some embodiments, responsive to the request to activate a virtual whiteboard, virtual whiteboard manager 122 can provide a virtual whiteboard UI element for presentation within each instance of the UI 300B at the client devices of the participants of the video conference.

FIG. 3C illustrates an example user interface 300C for a video conference where a user has added content to the virtual whiteboard, in accordance with some embodiments of the disclosure.

UI 300C shows a virtual whiteboard UI element 326 as the background layer of first region 316. UI 300C also displays visual item 321 corresponding to a video stream from the client device of Participant N. visual item 321 is placed in the foreground (e.g., foreground layer) of the first region 316. First region 316 of UI 300C also shows content 324 that includes content 324A, 324B, 324C and 324D that has been added to the virtual whiteboard UI element 326 element by Participant N.

In some embodiments, virtual whiteboard UI element 326 can fill the entirety of the background of a particular region, such as region 316. In some embodiments, the visual item 321, such as a video stream of the user, can be overlayed and opaque (or semi-transparent) to the background of virtual whiteboard UI element 326. In some embodiments, the virtual whiteboard UI element 326 can fill a part of the region 316. For example, the virtual whiteboard UI element 326 can be displayed in part of the first region 316 and visual item 321 can be displayed in another part of the first region 316. In some embodiments, the virtual whiteboard UI element 326 can be a separate region from the region of the video stream of the user, such as the video stream of Participant N in the current example.

Virtual whiteboard UI element 326 can display various types of content 324. In some embodiments, content 324 can include virtual elements such a sticky notes, emojis, stickers, and so forth. Content 324A illustrates an example of 3 sticky notes (sticky note 1, 2 and 3). In some embodiments, additional content can be added within the sticky notes. In some embodiments, the sticky notes can be re-arranged within the virtual whiteboard UI element 326. In some embodiments, the size of the sticky notes can be adjusted by the user. For instance, the user can drag the boundary of the sticky note to adjust the dimensions of the sticky note.

In some embodiments, content 324 can include templates such as graphs, coordinate paper, charts, cards, etc. Content 324B illustrates an example of coordinate paper (e.g., graph) paper) template.

In some embodiments, content 324 can include text. Content 324D illustrates text content that is displayed in virtual whiteboard UI element 326.

In some embodiments, content 324 can include free-form content. Content 324C illustrates free-form content that has been added to the coordinate paper template (e.g., content 324B). In some embodiments, free-form content is identified from a video gesture. For example, Participant N can draw the wavy line (illustrated in dashed lines near visual object 322B), and a computer vision operation can translate (direct translation) the video gesture into content 324C.

In some embodiments, virtual whiteboard manager 122 can identify an event (e.g., content event) associated with a client device of Participant N that identifies content for presentation within the virtual whiteboard UI element 326. The content 324 can be provided within a respective instance of the virtual whiteboard UI element 326 for presentation at multiple client devices associated with respective participants of the video conference.

In some embodiments, a user can use one or more input modalities to create, modify, or control content into the virtual whiteboard UI element 326. In some embodiments, the content event can include a selection of a UI element (not shown) of UI 300C that requests particular content be displayed (e.g., template content) in the virtual whiteboard UI element 326. In some embodiments, the content event can include a user input, such as a keyboard input, touch pad input, or mouse input that requests the creation, modification or control of content in the virtual whiteboard UI element 326 . . . . In some embodiments, the content event can include a voice command to create, modify or control content for the virtual whiteboard UI element 326. For example, virtual whiteboard manager 122 can use a speech-to-text operation to convert the user's speech into text that is to be displayed in the virtual whiteboard UI element 326.

In some embodiments, the content event can include a video gesture that is detected by virtual whiteboard manager 122, as discussed above with respect to FIG. 3B. In some embodiments, a video segment of the video stream associate with client device of participant N can be received by virtual whiteboard manager 122. Virtual whiteboard manager 122 can perform a computer vision operation on the video segment where the computer vision operation detects one or more video gestures associated with Participant N. Virtual whiteboard manager 122 determines content 324 (e.g., content 324C) based on the one or more video gestures.

In some embodiments, the video gestures detected can include gestures for moving a cursor to a location (e.g., point in the sentence), selecting an area of the virtual whiteboard UI element 326, selecting content within the virtual whiteboard UI element 326, and so forth.

In some embodiments, the video gesture can be directly translated such that the movements of the object, such as the participant's finger, are captured and directly rendered within the virtual whiteboard UI element 326 (e.g., content 324C). For instance, the direct translation can be a pixel-by-pixel translation with respect to the object and virtual whiteboard UI element 326. In another example, the participant can use handwriting (e.g., using a finger) and the video gesture can be directly rendered as handwritten letter and numbers, and so forth.

In some embodiments, the video gesture can be interpreted and rendered as an interpreted gesture within the virtual whiteboard UI element 326. For example, the participant can draw a line and video gesture of the line can be interpreted as a straight line even though the video gesture is not perfectly straight. In another example, the participant can use handwriting (e.g., using a finger) and the video gesture can interpret handwritten letter and numbers and convert the handwritten letters and numbers into text.

In some embodiments, a computer vision operation that monitors for one or more video gestures that identify content for the virtual whiteboard UI element 326 can be performed. In some embodiments, the computer vision operation that monitors for one or more video gestures that identify content for the virtual whiteboard UI element 326 can use all the frames (e.g., unsampled video frames) of a video segment of the video stream. In some embodiments, the computer vision operation can implement pose detection that identifies the position, orientation, and configuration of an object, such as the hand and finger, or other object (e.g., stylus or pen) among video frames of a video segment. Pose detection identifies the spatial relationships between different objects (e.g., fingers and palm) and tracks their movements over time. In some embodiments, the position of object(s) can be tracked relative to viewport over time. The tracked physical position of the object can be translated to a position on virtual whiteboard UI element 326. For example, the physical position of the hand can be translated to coordinates on the virtual whiteboard UI element 326 (e.g., coordinate data). The coordinate data can be translated into pixels within the virtual whiteboard UI element 326. The coordinate data can be recorded and used for the rendering and display of content. In some embodiments, the coordinate data can be used for direct translation of content or interpretation of content.

In some embodiments, as noted above, the computer vision operation that monitors for one or more video gestures that identify content for the virtual whiteboard UI element 326 can implement a ray casting operation. In some embodiments, a ray casting operation can include simulating rays or lines from a specific point in a particular direction and checking whether the rays or lines intersect with any objects in their path. In some embodiments, the ray casting operation simulates a line radiating from the object (e.g., from the tip of the finger or tip of a pen) and projects the line on a virtual plane at a fixed location (e.g., at some position within the UI 300). The virtual plane can represent a flat surface in the UI 300C. The location of the intersection of the line with the virtual plane can be recorded into coordinates (e.g., coordinate data), and the changes in the location of the intersection of the line with the virtual plane can also be recorded as coordinates with a timestamp (e.g., coordinate data). The coordinate data can be translated into pixels within the virtual whiteboard UI element 326. The coordinate data can be recorded and used for the rendering and display of content. In some embodiments, the coordinate data can be used for direct translation of content or interpretation of content.

FIG. 3D illustrates an example user interface 300D for a video conference where a different user has added content to the virtual whiteboard, in accordance with some embodiments of the disclosure.

UI 300D illustrates Participant A adding content 328 that includes content 328A, 328B and 328B to the virtual whiteboard UI element 326 in real-time. In some embodiments, and as illustrated in UI 300D the virtual whiteboard UI element 326 is still the background layer of Participant N's livestream even though Participant A is contributing content 328. In some embodiments and as noted above, the virtual whiteboard UI element 326 can be presented in region 316 of the UI 300D and the visual item 321 associated with the live stream of Participant N can be presented in another region. In some embodiments, virtual whiteboard UI element 326 can be presented as the background layer of Participant A's visual item associated with the video stream of Participant A.

In some embodiments, participant N can grant permission to one or more other participants of the conference call for content collaborate using virtual whiteboard UI element 326. In some embodiments, Participant N may select a GUI element of UI 300D that enables sharing of the virtual whiteboard UI element 326. In other embodiments, sharing of the virtual whiteboard UI element can be activated by other modalities, as described herein.

As illustrated in UI 300D, Participant A has erased some content, content 324D from the virtual whiteboard UI element 326. Participant A has selected template content, such as content 328A to include a coordinate paper template. Participant A has used a video gesture (as illustrated in dashed lines in second region 318) to draw a new graph (i.e., content 328B) within the coordinate paper template. Participant A has also added content 328C that includes text.

In some embodiments, content metadata can be recorded in a record. The content metadata can identify information about the content such identification of participant contributors associated with particular content, the time content was contributed, the location with respect to the virtual whiteboard UI element 326 where the content was added, modifications to any content (e.g., erase, add, move, etc.), among other information.

FIG. 3E illustrates an example user interface 300E for a video conference where a different participant has activated a new virtual whiteboard, in accordance with some embodiments of the disclosure.

In some embodiments, another participant of a video conference can request an activation of a virtual whiteboard. For example and as illustrated in UI 300E, Participant A has requested activation of a virtual whiteboard associated specifically with Participant A. UI 300E illustrates first region 316 that displays visual item 331 (that includes visual object 330A and visual object 330B) corresponding to a video stream from a client device associated with Participant A. Additionally, illustrates virtual whiteboard UI element 332 that includes content 328.

In some embodiments, participants can activate a virtual whiteboard that includes a new “clean” virtual whiteboard UI element (e.g., no content). In some embodiments, participants can activate a virtual whiteboard with existing or saved content. In some embodiments, a new virtual whiteboard UI element can clone the content of an existing or previous virtual whiteboard UI element in its entirety.

In some embodiments, content from one or more previous virtual whiteboard UI elements of a video conference can be retrieved and displayed on a new virtual whiteboard UI element based on a criterion. In some embodiments, virtual whiteboard manager 122 can filter content from one or more previous virtual whiteboard UI elements and provide the filtered content for presentation in a new virtual whiteboard UI element 332 at the respective client devices of the video conference.

For example, the content 324 and content 328 of virtual whiteboard UI element 326 of FIG. 3D can be filtered by one or more criteria, such as by participant contribution, a location in the virtual whiteboard UI element, time range, or specified virtual whiteboard UI element, among other criteria. Content metadata associated with content can be used to help perform a filtering operation. As illustrated in virtual whiteboard UI element 332, the content 328 has been filtered from the content (e.g., content 324 and content 328) of virtual whiteboard UI element 326 based on the criteria of participant contribution from virtual whiteboard UI element 326. In particular, content 324 and content 328 of virtual whiteboard UI element 326 has been filtered to include content contributed only by Participant A. Content contributed by Participant N has been filtered from the content of virtual whiteboard UI element 326.

FIG. 3F illustrates an example user interface 300D for a video conference where content of user interface 300D is used to produce a summary of the content, in accordance with some embodiments of the disclosure.

In some embodiments, virtual whiteboard manager 122 can convert content of one or more virtual whiteboard UI elements into content for a document application (e.g., document editing application), such as a word processing application, slide application, spreadsheet application, web-page or other application. In some embodiments, virtual whiteboard manager 122 can convert the content of one or more virtual whiteboard UI elements in a first format into a second format of a document application. In some embodiments, virtual whiteboard manager 122 can provide access to a file (e.g., document) of the document application where the file includes the content from one or more virtual whiteboard UI elements. The file can be shared among participant of the video conference.

As illustrated in FIG. 3F content 324 and 328 of virtual whiteboard UI element 326 is used to produce a document 334 of a document application. As illustrated, document 334 has been opened by the document application and displays a summary of the content 324 and 328 of virtual whiteboard UI element 326. In some embodiments, the summary can include new content using a machine learning model, such as a generative machine learning model.

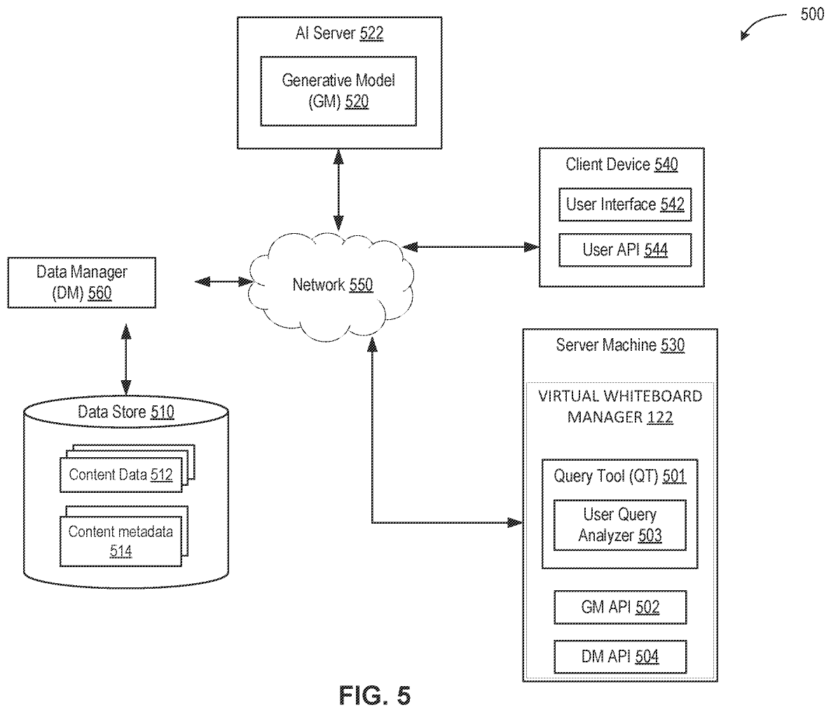

In some embodiments, virtual whiteboard UI element 332 can implement a machine learning model, such as a generative machine learning model (e.g., generative language model) to produce a summary of the content of one or more virtual whiteboard UI elements. The input to the trained generative machine learning model can include content presented within one or more virtual whiteboard UI elements, content modified within one or more virtual whiteboard UI elements (e.g., deleted, moved or altered content), and content metadata. The output of the trained generative machine learning model can include new content (e.g., summary of content) that is stored in a document file of a document application. A system that supports a generative machine learning model is further described with respect to FIG. 5.

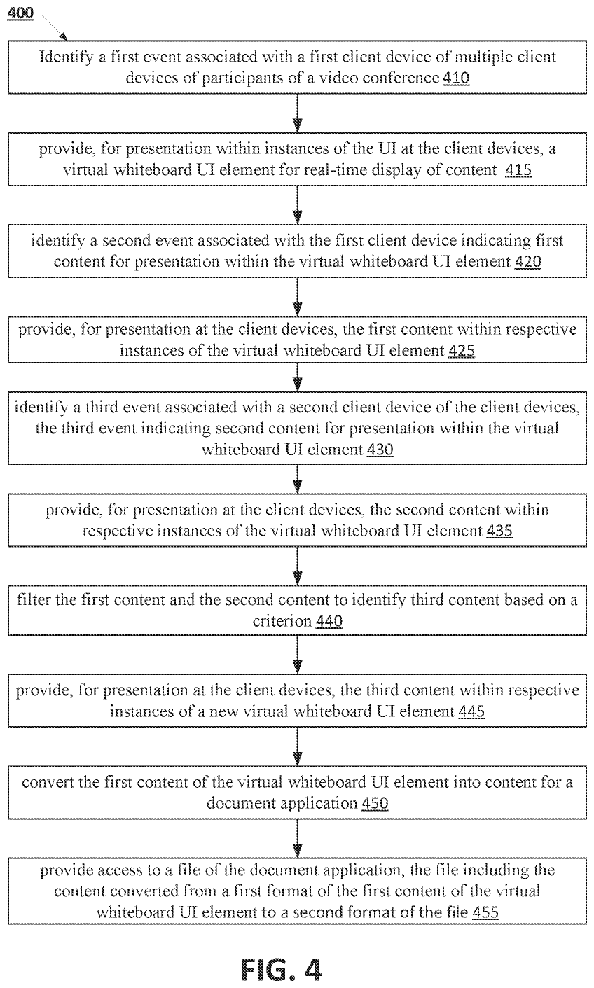

FIG. 4 depicts a flow diagram of a method 400 for implementing a virtual whiteboard for presentation in a user interface (UI) of a video conference, in accordance with embodiments of the disclosure. Method 400 may be performed by processing logic that may include hardware (circuitry, dedicated logic, etc.), software (e.g., instructions run on a processing device), or a combination thereof. In one embodiment, some or all the operations of method 400 may be performed by one or more components of system 100 of FIG. 1 (e.g., video conference platform 120, server 130 and/or virtual whiteboard manager 122).

For simplicity of explanation, the method 400 of this disclosure is depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events. Additionally, it should be appreciated that the method 400 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 410, the processing logic identifies a first event associated with a first client device of multiple client devices of participants of a video conference. In some embodiments, the first event indicates a request to activate a virtual whiteboard for presentation in a user interface (UI) that includes regions that display visual items each corresponding to one of the video streams from the client devices.

In some embodiments, to identify the first event associated with the first client device of the multiple client devices of the participants of the video conference, processing logic receives, from the first client device, a first video segment of a first video stream of the multiple video streams. In some embodiments, processing logic can perform a first computer vision operation on the first video segment to detect a video gesture that qualifies as a predetermined video gesture indicative of the request to activate the virtual whiteboard for presentation in the UI.

In some embodiments, to perform the first computer vision operation on the first video segment to detect the video gesture that qualifies as the predetermined video gesture indicative of the request to activate the virtual whiteboard for presentation in the UI, processing logic samples a subset of frames of the first video segment. In some embodiments, processing logic performs the first computer vision operation on the subset of frames of the first video segment.

In some embodiments, to identify the first event associated with the first client device of the multiple client devices of the participants of the video conference, processing logic receives an indication of a user selection of a UI element of the UI that indicates the request to activate the virtual whiteboard for presentation in the UI.

At operation 415, processing logic provides for presentation within instances of the UI at the client devices, a virtual whiteboard UI element for real-time display of content among the participants of the video conference. In some embodiments, operation 415 is performed responsive to identifying the first event.

In some embodiments, the virtual whiteboard UI element is presented as a background layer of a first visual item of the multiple visual items. In some embodiments, the first visual item represents a first video stream from the first client device.

At operation 420, processing logic identifies a second event associated with the first client device indicating first content for presentation within the virtual whiteboard UI element.

In some embodiments, to identify the second event associated with the first client device indicating the first content for presentation within the virtual whiteboard UI element, processing logic receives, from the first client device, a second video segment of a second video stream of the multiple video streams. In some embodiments, processing logic performs, on the second video segment, a second computer vision operation that detects one or more video gestures associated with a first user of the first client device. In some embodiments, processing logic determines the first content based on the one or more video gestures associated with the first user.

In some embodiments, to perform, on the second video segment, the second computer vision operation that detects one or more video gestures associated with the first user of the first client device, processing logic performs the second computer vision operation on all frames of the second video segment.

In some embodiments, to perform, on the second video segment, the second computer vision operation that detects one or more video gestures associated with the first user of the first client device, processing logic performs a ray casting operation that projects a line from an object associated with the first user to a location on a virtual plane. In some embodiments, processing logic detects changes in the location of the line on the virtual plane based on movement of the object.

At operation 425, processing logic provides, for presentation at the client devices, the first content within respective instances of the virtual whiteboard UI element.

At operation 430, processing logic identifies a third event associated with a second client device of the multiple client devices. In some embodiments, the third event indicates second content for presentation within the virtual whiteboard UI element.

At operation 435, processing logic provides, for presentation at the multiple client devices, the second content within respective instances of the virtual whiteboard UI element for real-time collaboration.

At operation 440, processing logic filters the first content and the second content to identify third content based on a criterion.

At operation 445, processing logic provides, for presentation at the multiple client devices, the third content within respective instances of a new virtual whiteboard UI element.

At operation 450, processing logic converts the first content of the virtual whiteboard UI element into content for a document application.

At operation 455, processing logic provides access to a file of the document application. In some embodiments, the file includes the content converted from a first format of the first content of the virtual whiteboard UI element to a second format of the file.

FIG. 5 illustrates a high-level component diagram of an example system architecture 500 for a generative machine learning model, in accordance with one or more aspects of the disclosure. The system architecture 500 (also referred to as “system” herein) includes a data store 510, a generative model 520 provided by AI server 522, a server machine 530 with a query tool (QT) 501, one or more client devices 540, and/or other components connected to a network 550. In some embodiments, network 550 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), and/or the like. In some embodiments, network 550 may include routers, hubs, switches, server computers, and/or a combination thereof.

In some embodiments, any of AI server 522, server machine 530, and/or client device(s) 540 may include a desktop computer, a laptop computer, a smartphone, a tablet computer, a server, a scanner, or any suitable computing device capable of performing the techniques described herein. In some embodiments, any of server machine 530 and/or client device(s) 540 may be (and/or include) one or more computer systems 100 of FIG. 1.

In some embodiments, data store 510 (database, data warehouse, etc.) may store any suitable raw and/or processed data, e.g., content data 512. For example, content data 512 may include content for one or more virtual whiteboard UI elements, modifications to content for one or more virtual whiteboard UI elements. Content data 512 may also include user's consent to store user's content data and/or use user's data in information exchanges with generative model (GM) 520. Data store 510 may further store content meta data 514.

System 500 may further include a data manager (DM) 560 that may be any application configured to manage data transport to and from data store 510, e.g., retrieval of data and/or storage of new data, indexing data, arranging data by user, time, type of activity to which the data is related, associating the data with keywords, and/or the like. DM 560 may collect data associated with various user activities, e.g., content for virtual whiteboard UI elements, applications, internal tools, and/or the like. DM 560 may collect, transform, aggregate, and archive such data in data store 510. In some embodiments, DM 560 may support a suitable software that, with user's consent, resides on client device(s) 540 and tracks user activities. For example, the DM-supported software may capture user-generated content and convert the captured content into a format that can be used by various content destinations, e.g., QT 501. In some embodiments, the DM-supported software may be a code snippet integrated into user's browsers/apps and/or websites visited by the user. Generating, tracking, and transmitting data may be facilitated by one or more libraries of DM 560. In some embodiments, data may be transmitted using messages in the JSON format. A message may include a user digital identifier, a timestamp, name and version of a library that generated the message, page path, user agent, operating system, settings. A message may further include various user traits, which should be broadly understood as any contextual data associated with user's activities and/or preferences. DM 560 may track different ways the same user DM 560 may facilitate data suppression/deletion in accordance with various data protection and consumer protection regulations. DM 560 may validate data, convert data into a target format, identify and eliminate duplicate data, and/or the like. DM 560 may aggregate data, e.g., identify and combine data associated with a given user in the user's profile (user's persona), and storing the user's profile on a single memory partition. DM 560 may scan multiple user's profiles to identify and group users that are related to the same organization, activity, interests, and/or the like. DM 560 may scan numerous user's actions and identify user's profiles associated with multiple uses of a particular resource (e.g., virtual whiteboard UI element). DM may ensure reliable delivery of data from user profiles (user personas) to recipients of that data, e.g., by tracking and re-delivering (re-routing) data whose transmission failed.

Data store 510 may be implemented in a persistent storage capable of storing files as well as data structures to perform identification of data, in accordance with embodiments of the disclosure. Data store 510 may be hosted by one or more storage devices, such as main memory, magnetic or optical storage disks, tapes, or hard drives, network-attached storage (NAS), storage area network (SAN), and so forth. Although depicted as separate from the server machine 530, data store 510 may be part of server machine 530, and/or other devices. In some embodiments, data store 510 may be implemented on a network-attached file server, while in other embodiments data store 510 may be implemented on some other types of persistent storage, such as an object-oriented database, a relational database, and so forth, that may be hosted by a server machine 530 or one or more different machines coupled to server machine 530 via network 550.

Server machine 530 may include QT 501 configured to perform automated identification and facilitate retrieval of relevant and timely contextual information for quick and accurate processing of user queries by generative model 520, as disclosed herein. In some embodiments, QT 501 may be implemented by virtual whiteboard manager 122. It can be noted that a user's request to convert content of one or more virtual whiteboard UI elements in to a summary notes can be formed into a query that uses QT 501 in some embodiments. Via network 550, QT 501 may be in communication with one or more client devices 540, AI server 522, and data store 510, e.g., via DM 560. Communications between QT 501 and AI server 522 may be facilitated by GM API 502. Communications between QT 501 and data store 510/DM 560 may be facilitated by DM API 504. Additionally, GM API 502 may translate various queries generated by QT 501 into unstructured natural-language format and, conversely, translate responses received from generative model 520 into any suitable form (including any structured proprietary format as may be used by QT 501). Similarly, DM API 504 may support instructions that may be used to communicate data requests to DM 560 and formats of data received from data store 510 via DM 560.

A user (e.g., participant, etc.) may interact with QT 501 via a user interface (UI) 542. In some embodiments, UI 542 may be similar to UI 124 of FIG. 1. In some embodiments, UI 542 may be implemented in UI 124 of FIG. 1. For example, UI 542 can be a UI element of UI 124. UI 542 may support any suitable types of user inputs, e.g., content from virtual whiteboard UI elements, speech inputs (captured by a microphone), text inputs (entered using a keyboard, touchscreen, or any pointing device), camera (e.g., for recognition of sign language), and/or the like, or any combination thereof. UI 542 may further support any suitable types of outputs, e.g., speech outputs (via one or more speaker), text, graphics, and/or sign language outputs (e.g., displayed via any suitable screen), file for a word editing application, and/or the like, or any combination thereof. In some embodiments, UI 542 may be a web-based UI (e.g., a web browser-supported interface), a mobile application-supported UI, or any combination thereof. UI 542 may include selectable items. In some embodiments, UI 542 may allow a user to select from multiple (e.g., specialized in particular knowledge areas) generative models 520. UI 542 may allow the user to provide consent for QT 501 and/or generative model 520 to access user data previously stored in data store 510 (and/or any other memory device), process and/or store new data received from the user, and the like. UI 542 may allow the user to withhold consent to provide access to user data to QT 501 and/or generative model 520. In some embodiments, user inputs entered via UI 542 may be communicated to QT 501 via a user API 544. In some embodiments, UI 542 and user API 544 may be located on client device 540 that the user is using to QT 501. For example, an API package with user API 544 and/or user interface 542 may be downloaded to client device 540. The downloaded API package may be used to install user API 544 and/or user interface 542 to enable the user to have two-way communication with QT 501.

QT 501 may include a user query analyzer 503 to support various operations of this disclosure. For example, user query analyzer 503 may receive a user input, e.g., user query, and generate one or more intermediate queries to generative model 520 to determine what type of user data GM 520 might need to successfully respond to user input. Upon receiving a response from GM 520, user query analyzer 503 may analyze the response, form a request for relevant contextual data for DM 560, which may then supply such data. User query analyzer 503 may then generate a final query to GM 520 that includes the original user query and the contextual data received from DM 560. In some embodiments, user query analyzer 503 may itself include a lightweight generative model that may process the intermediate query (ies) and determine what type of contextual data may have to be provided to GM 520 together with the original user query to ensure a meaningful response from GM 520.

QT 501 may include (or may have access to) instructions stored on one or more tangible, machine-readable storage media of server machine 530 and executable by one or more processing devices of server machine 530. In one embodiment, QT 501 may be implemented on a single machine (e.g., as depicted in FIG. 5). In some embodiments, QT 501 may be a combination of a client component and a server component. In some embodiments QT 501 may be executed entirely on the client device(s) 540. Alternatively, some portion of QT 501 may be executed on a client computing device while another portion of QT 501 may be executed on server machine 530.

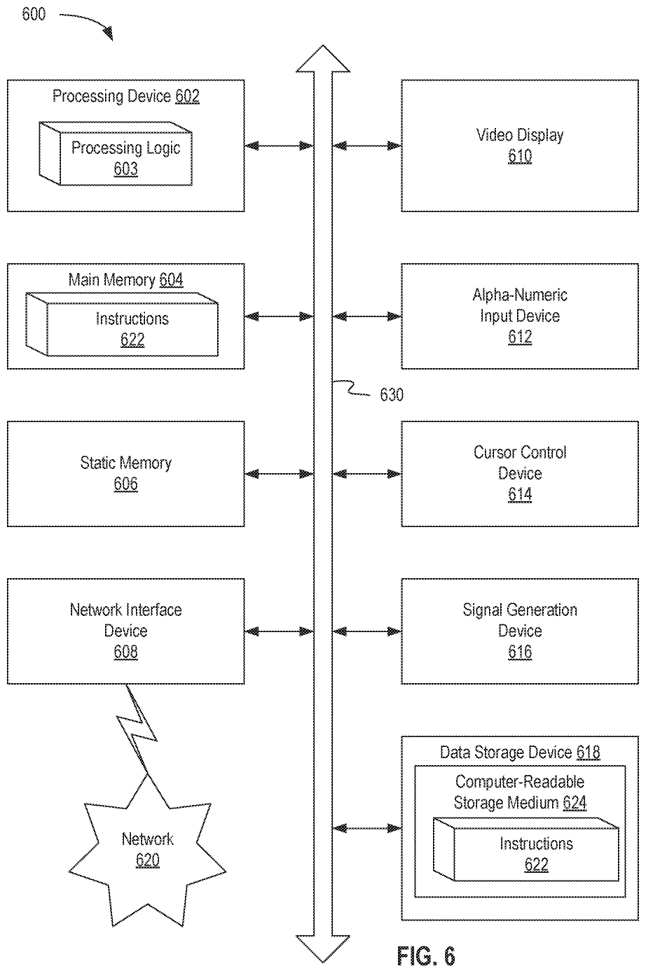

FIG. 6 depicts an example computer system 600 that can perform any one or more of the methods described herein, in accordance with some embodiments of the disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 618, which communicate with each other via a bus 630.

Processing device 602 (which can include processing logic 603 implementing virtual whiteboard manager 122) represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 622 for implementing virtual whiteboard manager 122.

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker). In one illustrative example, the video display unit 610, the alphanumeric input device 612, and the cursor control device 614 may be combined into a single component or device (e.g., an LCD touch screen).

The data storage device 618 may include a computer-readable storage medium 624 on which is stored the instructions 622 implementing virtual whiteboard manager 122 and/or embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable media. In some embodiments, the instructions 622 may further be transmitted or received over a network 620 via the network interface device 608.

While the computer-readable storage medium 624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain embodiments, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the disclosure may be practiced without these specific details. In some instances, well-known structures and devices are shown in block diagram form, rather than in detail, in order to avoid obscuring the disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the disclosure are not described with reference to any particular programming language. It will be appreciated that a variety of programming languages may be used to implement the teachings of the disclosure as described herein.

Aspects of the disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

Finally, embodiments described herein include collection of data describing a user and/or activities of a user. In one embodiment, such data is only collected upon the user providing consent to the collection of this data. In some embodiments, a user is prompted to explicitly allow data collection. Further, the user may opt-in or opt-out of participating in such data collection activities. In one embodiment, the collect data is anonymized prior to performing any analysis to obtain any statistical patterns so that the identity of the user cannot be determined from the collected data.

What is claimed is:

1. A method comprising:
identifying a first event associated with a first client device of a plurality of client devices of a plurality of participants of a video conference, the first event indicating a request to activate a virtual whiteboard for presentation in a user interface (UI) comprising a plurality of regions that display a plurality of visual items each corresponding to one of a plurality of video streams from the plurality of client devices;
responsive to identifying the first event, providing, for presentation within instances of the UI at the plurality of client devices, a virtual whiteboard UI element for real-time display of content among the plurality of participants of the video conference;
identifying a second event associated with the first client device indicating first content for presentation within the virtual whiteboard UI element; and
providing, for presentation at the plurality of client devices, the first content within respective instances of the virtual whiteboard UI element.

2. The method of claim 1, wherein identifying the first event associated with the first client device of the plurality of client devices of the plurality of participants of the video conference, comprises:
receiving, from the first client device, a first video segment of a first video stream of the plurality of video streams; and
performing a first computer vision operation on the first video segment to detect a video gesture that qualifies as a predetermined video gesture indicative of the request to activate the virtual whiteboard for presentation in the UI.

3. The method of claim 2, wherein identifying the second event associated with the first client device indicating the first content for presentation within the virtual whiteboard UI element, comprises:
receiving, from the first client device, a second video segment of a second video stream of the plurality of video streams;
performing, on the second video segment, a second computer vision operation that detects one or more video gestures associated with a first user of the first client device; and
determining the first content based on the one or more video gestures associated with the first user.

4. The method of claim 3, wherein performing the first computer vision operation on the first video segment to detect the video gesture that qualifies as the predetermined video gesture indicative of the request to activate the virtual whiteboard for presentation in the UI, comprises:
sampling a subset of frames of the first video segment;
performing the first computer vision operation on the subset of frames of the first video segment; and
wherein performing, on the second video segment, the second computer vision operation that detects one or more video gestures associated with the first user of the first client device, comprises:
performing the second computer vision operation on a plurality of frames of the second video segment.

5. The method of claim 3, wherein performing, on the second video segment, the second computer vision operation that detects one or more video gestures associated with the first user of the first client device, comprises:
performing a ray casting operation that projects a line from an object associated with the first user to a location on a virtual plane and detects changes in the location on the virtual plane based on movement of the object.

6. The method of claim 1, wherein the virtual whiteboard UI element is presented as a background layer of a first visual item of the plurality of visual items, the first visual item representing a first video stream from the first client device.

7. The method of claim 1, wherein identifying the first event associated with the first client device of the plurality of client devices of the plurality of participants of the video conference, comprises:
receiving an indication of a user selection of a UI element of the UI that indicates the request to activate the virtual whiteboard for presentation in the UI.

8. The method of claim 1, further comprising:
identifying a third event associated with a second client device of the plurality of client devices, the third event indicating second content for presentation within the virtual whiteboard UI element; and
providing, for presentation at the plurality of client devices, the second content within respective instances of the virtual whiteboard UI element.

9. The method of claim 8, further comprising:
filtering the first content and the second content to identify third content based on a criterion; and
providing, for presentation at the plurality of client devices, the third content within respective instances of a new virtual whiteboard UI element.

10. The method of claim 1, further comprising:
converting the first content of the virtual whiteboard UI element into content for a document application; and
providing access to a file of the document application, the file comprising the content converted from a first format of the first content of the virtual whiteboard UI element to a second format of the file.

11. A system comprising:
a memory; and
a processing device, coupled to the memory, to perform operations comprising:
identifying a first event associated with a first client device of a plurality of client devices of a plurality of participants of a video conference, the first event indicating a request to activate a virtual whiteboard for presentation in a user interface (UI) comprising a plurality of regions that display a plurality of visual items each corresponding to one of a plurality of video streams from the plurality of client devices;
responsive to identifying the first event, providing, for presentation within instances of the UI at the plurality of client devices, a virtual whiteboard UI element for real-time display of content among the plurality of participants of the video conference;
identifying a second event associated with the first client device indicating first content for presentation within the virtual whiteboard UI element; and
providing, for presentation at the plurality of client devices, the first content within respective instances of the virtual whiteboard UI element.

12. The system of claim 11, wherein identifying the first event associated with the first client device of the plurality of client devices of the plurality of participants of the video conference, comprises:
receiving, from the first client device, a first video segment of a first video stream of the plurality of video streams; and
performing a first computer vision operation on the first video segment to detect a video gesture that qualifies as a predetermined video gesture indicative of the request to activate the virtual whiteboard for presentation in the UI.

13. The system of claim 12, wherein identifying the second event associated with the first client device indicating the first content for presentation within the virtual whiteboard UI element, comprises:
receiving, from the first client device, a second video segment of a second video stream of the plurality of video streams;
performing, on the second video segment, a second computer vision operation that detects one or more video gestures associated with a first user of the first client device; and
determining the first content based on the one or more video gestures associated with the first user.

14. The system of claim 13, wherein performing the first computer vision operation on the first video segment to detect the video gesture that qualifies as the predetermined video gesture indicative of the request to activate the virtual whiteboard for presentation in the UI, comprises:
sampling a subset of frames of the first video segment;
performing the first computer vision operation on the subset of frames of the first video segment; and
wherein performing, on the second video segment, the second computer vision operation that detects one or more video gestures associated with the first user of the first client device, comprises:
performing the second computer vision operation on a plurality of frames of the second video segment.

15. The system of claim 13, wherein performing, on the second video segment, the second computer vision operation that detects one or more video gestures associated with the first user of the first client device, comprises:
performing a ray casting operation that projects a line from an object associated with the first user to a location on a virtual plane and detects changes in the location on the virtual plane based on movement of the object.

16. The system of claim 11, wherein the virtual whiteboard UI element is presented as a background layer of a first visual item of the plurality of visual items, the first visual item representing a first video stream from the first client device.

17. The system of claim 11, wherein identifying the first event associated with the first client device of the plurality of client devices of the plurality of participants of the video conference, comprises:
receiving an indication of a user selection of a UI element of the UI that indicates the request to activate the virtual whiteboard for presentation in the UI.

18. The system of claim 10, the operations further comprising:
identifying a third event associated with a second client device of the plurality of client devices, the third event indicating second content for presentation within the virtual whiteboard UI element; and
providing, for presentation at the plurality of client devices, the second content within respective instances of the virtual whiteboard UI element.

19. A non-transitory computer-readable medium that, responsive to an execution of instruction by a processing device, cause the processing device to perform operations comprising:
identifying a first event associated with a first client device of a plurality of client devices of a plurality of participants of a video conference, the first event indicating a request to activate a virtual whiteboard for presentation in a user interface (UI) comprising a plurality of regions that display a plurality of visual items each corresponding to one of a plurality of video streams from the plurality of client devices;
responsive to identifying the first event, providing, for presentation within instances of the UI at the plurality of client devices, a virtual whiteboard UI element for real-time display of content among the plurality of participants of the video conference;
identifying a second event associated with the first client device indicating first content for presentation within the virtual whiteboard UI element; and
providing, for presentation at the plurality of client devices, the first content within respective instances of the virtual whiteboard UI element.

20. The A non-transitory computer-readable medium of claim 10, wherein identifying the first event associated with the first client device of the plurality of client devices of the plurality of participants of the video conference, comprises:
receiving, from the first client device, a first video segment of a first video stream of the plurality of video streams; and
performing a first computer vision operation on the first video segment to detect a video gesture that qualifies as a predetermined video gesture indicative of the request to activate the virtual whiteboard for presentation in the UI.
